(19) United States
(12) Patent Application Publication
(10) Pub. No.: US 2025/0042477 A1
(43) Pub. Date: Feb. 6, 2025

(54) CAB MOUNT

(71) Applicants: SUMITOMO RIKO COMPANY LIMITED, Komaki-shi (JP); TOYOTA JIDOSHA KABUSHIKI KAISHA, Toyota-shi (JP)

(72) Inventors: Takayuki Goto, Komaki-shi (JP); Tatsunori Taniguchi, Komaki-shi (JP); Tetsuya Asai, Miyoshi-shi (JP); Masahiro Hirao, Sunto-gun (JP); Shouji Katsumata, Gotemba-shi (JP)

(73) Assignees: SUMITOMO RIKO COMPANY LIMITED, Komaki-shi (JP); TOYOTA JIDOSHA KABUSHIKI KAISHA, Toyota-shi (JP)

(21) Appl. No.: 18/921,087

(22) Filed: Oct. 21, 2024

Related U.S. Application Data
(63) Continuation of application No. PCT/JP2023/043315, filed on Dec. 4, 2023.

(30) Foreign Application Priority Data
Dec. 26, 2022 (JP) 2022-208145

(51) Int. Cl. B62D 24/02; F16F 15/08

(52) U.S. Cl. CPC B62D 24/02; F16F 15/08

(57) ABSTRACT

A cab mount including: an upper mount and a lower mount configured to be assembled as sandwiching a first vehicle member; a fixing shaft inserted through the upper mount and the lower mount so as to fix the cab mount to a second vehicle member; an elastic body constituting the upper mount; an insertion rubber part provided at a lower end of the elastic body and configured to extend between the first vehicle member and the fixing shaft in a radial direction; and a reinforcement member including a tubular portion that extends in an axial direction and being embedded in and bonded to a lower portion of the elastic body, the reinforcement member being arranged off to an upper side of the insertion rubber part.

### INCORPORATED BY REFERENCE

This application is a Continuation of International Application No. PCT/JP2023/043315 filed Dec. 4, 2023, which claims priority under 35 U.S.C. §§ 119 (a) and 365 of Japanese Patent Application No. 2022-208145 filed on Dec. 26, 2022, the disclosures of which are expressly incorporated herein by reference in their entireties.

### BACKGROUND ART

### 1. Technical Field

The present disclosure relates to a cab mount that is interposed between a cabin (a driver's cab) and a chassis frame in an automobile.

### 2. Description of the Related Art

Conventionally, frame structures have been widely used in automobiles such as sport utility vehicles (SUVs) and trucks, in which the cabin is supported in a vibration-damping manner by the cab mount in relation to the chassis frame to which running wheels are attached by a suspension mechanism. For example, the structure shown in Japanese Unexamined Patent Publication No. JP-A-2021-092248 is known as this cab mount. That is, the cab mount has an upper mount and a lower mount assembled as sandwiching a first vehicle member (the chassis frame), and is fixed to a second vehicle member (the cabin) by a fixing shaft inserted through the upper mount and the lower mount. When a load is input in the direction of approach between the first vehicle member and the second vehicle member (the bound direction), the upper mount is compressed and deformed to elastically support the load and exhibit attenuating action owing to internal friction and the like. When a load is input in the direction of separation between the first vehicle member and the second vehicle member (the rebound direction), the lower mount is compressed and deformed to elastically support the load and exhibit attenuating action owing to internal friction and the like.

### SUMMARY

By the way, it is undesirable for cab mounts to have excessively high spring constants in the axial direction and the axis-perpendicular direction from the viewpoint of securing good ride comfort performance, etc. On the other hand, it is effective to set a large spring constant in the prizing direction in the upper mount, so as to suppress rolling of the cabin when the vehicle is turning, for example.

However, with conventional cab mounts, increasing the spring constant of the upper mount in the prizing direction makes it difficult to avoid an increase in the spring constants in the axial direction and the axis-perpendicular direction.

It is therefore one object of the present disclosure to provide a cab mount of a novel structure which is able to set a large spring constant in the prizing direction while suppressing the increase in the spring constants in the axial direction and the axis-perpendicular direction.

Hereinafter, preferred embodiments for grasping the present disclosure will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment provides a cab mount comprising: an upper mount and a lower mount configured to be assembled as sandwiching a first vehicle member; a fixing shaft inserted through the upper mount and the lower mount so as to fix the cab mount to a second vehicle member; an elastic body constituting the upper mount; an insertion rubber part provided at a lower end of the elastic body and configured to extend between the first vehicle member and the fixing shaft in a radial direction; and a reinforcement member including a tubular portion that extends in an axial direction and being embedded in and bonded to a lower portion of the elastic body, the reinforcement member being arranged off to an upper side of the insertion rubber part.

With the cab mount structured in accordance with the present preferred embodiment, the reinforcement member is bonded to the lower portion of the elastic body in the upper mount, thereby making it possible to set a large spring constant in the prizing direction. In particular, the reinforcement member has a tubular portion extending in the axial direction, which ensures a large working area of compression or tension of the elastic body by the reinforcement member upon input in the prizing direction acting in the tilting direction of the tubular portion, thereby setting a large spring constant in the prizing direction.

The tubular portion of the reinforcement member has a small projected area in the axial direction because it extends in the axial direction, and there is little effect on the spring constant in the axial direction caused by the tubular portion being bonded to the elastic body. In addition, the reinforcement member is located off to the upper side of the insertion rubber part, which has a large influence on the spring constant in the axis-perpendicular direction and acts dominantly, so the influence on the spring constant in the axis-perpendicular direction is also reduced. Owing to the shape and arrangement of the reinforcement member, it becomes possible to suppress the increase in the spring constants in the axial direction and the axis-perpendicular direction while increasing the spring constant in the prizing direction.

A second preferred embodiment provides the cab mount according to the first preferred embodiment, wherein a lower end of the tubular portion has an inner flanged portion projecting inward in the radial direction.

With the cab mount structured according to the present preferred embodiment, a relative tilting of the first vehicle member and the inner flanged portion occurs during input in the prizing direction, and a compressive force is exerted on the elastic body between the inner flanged portion and the first vehicle member, thereby achieving harder spring characteristics. In particular, since the inner flanged portion is provided at the lower end of the tubular portion close to the first vehicle member, the spring constant in the prizing direction can be efficiently increased.

A third preferred embodiment provides the cab mount according to the first or second preferred embodiment, wherein an upper end of the tubular portion has an outer flanged portion projecting outward in the radial direction.

With the cab mount structured according to the present preferred embodiment, a portion of the elastic body is compressed between the outer flanged portion and the first vehicle member during input in the prizing direction, thereby realizing harder spring characteristics. The outer flanged portion is provided projecting outward in the radial direction. Upon input in the prizing direction, the outer flanged portion tilts relative to the first vehicle member, resulting in compression of the elastic body, and then the compressed elastic body tries to escape upward in the axial direction. The outer flanged portion acts to suppress this escape of the elastic body, thereby further increasing the prizing spring, so that the outer flanged portion effectively contributes to increasing the spring constant in the prizing direction even when the outer flanged portion is provided at the upper end of the tubular portion far from the first vehicle member.

A fourth preferred embodiment provides the cab mount according to any one of the first through third preferred embodiments, wherein the reinforcement member is embedded in and bonded to an annular separate rubber, and the separate rubber is attached to a lower portion of a main rubber so as to constitute the elastic body so that the reinforcement member is embedded in and bonded to the lower portion of the elastic body.

With the cab mount having the structure according to the present preferred embodiment, the elastic body has a structure wherein the separate rubber is attached to the main rubber and the reinforcement member is bonded to the separate rubber. Owing to this structure, it becomes possible to increase the degree of freedom in selecting the material of the elastic body (the main rubber) without considering, for example, the bonding property of the reinforcement member, and to facilitate the positioning structure of the reinforcement member in the mold for molding the elastic body (the main rubber), and it becomes easy to change the design of the shape of the reinforcement member, and the like without changing the elastic body (the main rubber).

A fifth preferred embodiment provides the cab mount according to any one of the first through fourth preferred embodiments, configured to be used for the first vehicle member having an attachment recess opening upward which is provided at a radially inner portion thereof, wherein the lower portion of the elastic body is configured to be fitted into the attachment recess so that the reinforcement member bonded to the lower portion of the elastic body enters the attachment recess.

With the cab mount structured according to this preferred embodiment, the distance between the reinforcement member and the first vehicle member can be made closer by housing the reinforcement member in the attachment recess, and the increase in the spring constant in the prizing direction by providing the reinforcement member is advantageously realized.

A sixth preferred embodiment provides the cab mount according to the fifth preferred embodiment, wherein an inner diameter dimension of the reinforcement member is larger than an inner diameter dimension of the first vehicle member, and an outer diameter dimension of the reinforcement member is smaller than an inside dimension of the attachment recess.

With the cab mount structured according to this preferred embodiment, the entire reinforcement member is overlapped with the attachment recess of the first vehicle member without sticking out, as viewed in the axial direction. Therefore, a higher spring in the prizing direction is efficiently realized by compressive or tensile deformation of the elastic body between the entire reinforcement member and the first vehicle member. In addition, the effect of the reinforcement member on the spring constant in the axial direction gets smaller, and the increase in the spring constant in the axial direction is suppressed.

A seventh preferred embodiment provides the cab mount according to any one of the first through sixth preferred embodiments, wherein in an upper portion of the elastic body, a constricted, bored portion is formed opening to an outer peripheral surface thereof, and the reinforcement member is overlapped with the bored portion as viewed in the axial direction.

With the cab mount structured according to this preferred embodiment, the spring constant of the elastic body in the axial direction is reduced by the bored portion formed in the upper portion of the elastic body. Moreover, the reinforcement member is overlapped with the bored portion as viewed in the axial direction, thereby reducing the effect of the reinforcement member on the spring constant in the axial direction.

An eighth preferred embodiment provides the cab mount according to any one of the first through seventh preferred embodiments, wherein an inner diameter dimension of the insertion rubber part varies in a circumferential direction and the insertion rubber part is flower-shaped as viewed in the axial direction.

With the cab mount structured according to the present preferred embodiment, the portions contacting the fixing shaft inserted through the rubber insert part and the portions separated from the fixing shaft are alternately arranged in the circumferential direction, which makes tuning of the spring characteristics easier than when the rubber insert part contacts the fixing shaft over the entire circumference. In particular, since the insertion rubber part has a significant influence on the spring characteristics in the axis-perpendicular direction, it becomes easier to obtain soft spring characteristics in the axis-perpendicular direction.

The present disclosure makes it possible to set a large spring constant in the prizing direction while suppressing the increase in the spring constants in the axial direction and the axis-perpendicular direction in the cab mount.

### BRIEF DESCRIPTION OF THE DRAWINGS

The foregoing and/or other objects, features and advantages of the disclosure will become more apparent from the following description of practical embodiments with reference to the accompanying drawings in which like reference numerals designate like elements and wherein:

FIG. 1 is a vertical cross section view showing a cab mount as a first practical embodiment of the present disclosure in a state of being mounted on a vehicle, taken along line 1-1 of FIG. 3;

FIG. 2 is a vertical cross section view showing only an upper mount of the cab mount shown in FIG. 1, taken along line 2-2 of FIG. 3;

FIG. 3 is a bottom view of the upper mount shown in FIG. 2;

FIG. 4 is a vertical cross section view showing only a lower mount of the cab mount shown in FIG. 1;

FIG. 5 is a vertical cross section view showing a cab mount as a second practical embodiment of the present disclosure in a state of being mounted on a vehicle; and

FIG. 6 is a vertical cross section view showing only an upper mount of the cab mount shown in FIG. 5.

### DETAILED DESCRIPTION

There will be described practical embodiments of the present disclosure with reference to the drawings.

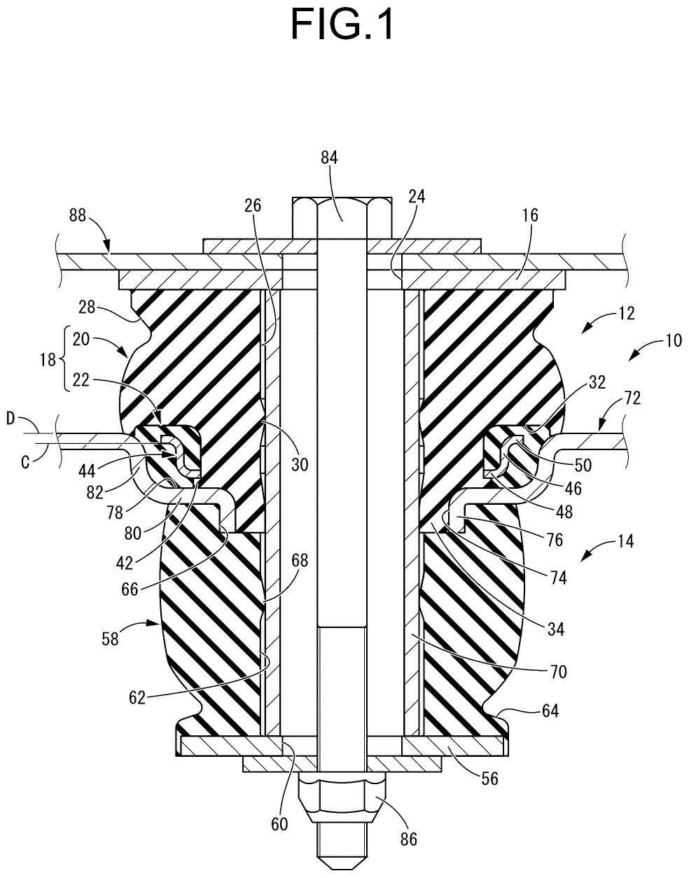

FIG. 1 shows a cab mount 10 for an automobile as a first practical embodiment of the present disclosure. The cab mount 10 comprises an upper mount 12 and a lower mount 14. In the following description, as a general rule, the up-down direction is the up-down direction in FIG. 1, which is the axial direction of the cab mount 10.

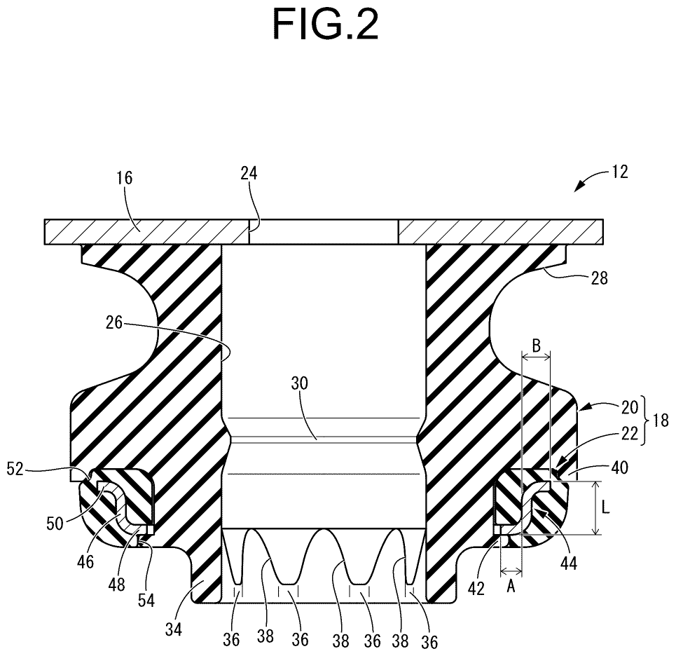

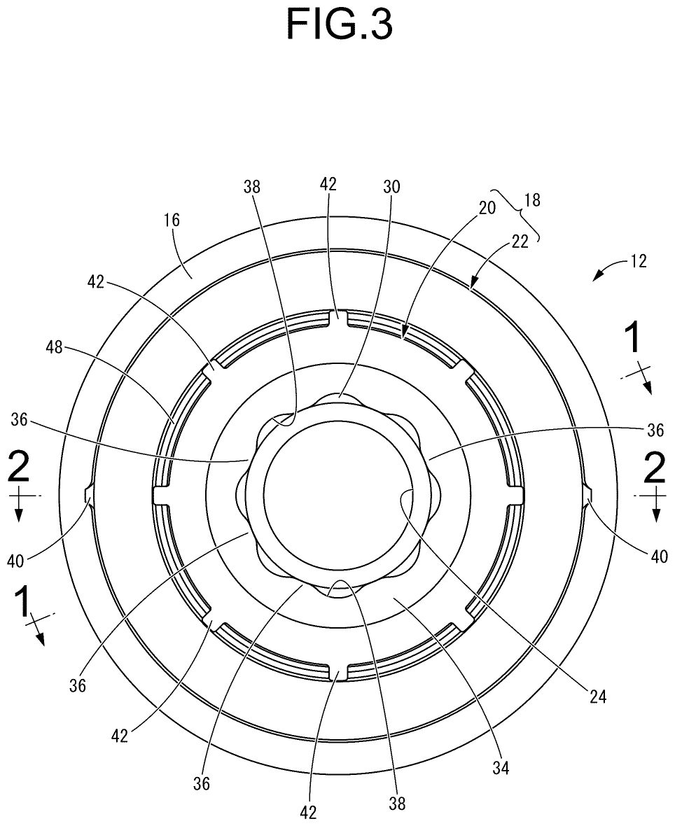

As shown in FIGS. 2 and 3, the upper mount 12 is tubular as a whole and has a structure wherein a first elastic body 18 as an elastic body is adhered to an upper plate 16. The upper plate 16 is a member of an approximately annular plate shape formed of a metal or the like, and a first bolt insertion hole 24 is formed through the center portion of the upper plate 16 in the thickness direction.

The first elastic body 18 includes a main rubber 20 and a separate rubber 22. The main rubber 20 is formed of a rubber or a resin elastomer. The main rubber 20 has a roughly cylindrical shape with a first inner hole 26 penetrating it in the up-down direction. In the upper portion of the main rubber 20, a first bored portion 28 as a bored portion opening to the outer peripheral surface is continuously formed over the entire circumference of the main rubber 20. The first bored portion 28 of the present practical embodiment has a widened shape with an axial width dimension that increases to the outer peripheral side, and has a generally constant cross-sectional shape over the entire circumference. The depth dimension of the first bored portion 28 is suitably ⅓ times the radial thickness dimension of the upper portion of the main rubber 20 or more, and in the present practical embodiment, it is approximately half.

A first intermediate lip 30 projecting radially inward is provided on the radially inner surface of the main rubber 20. The first intermediate lip 30 has a tapered cross-sectional shape that becomes narrower in the axial direction as it goes toward the projecting tip, and is formed continuously over the entire circumference. The apex of the first intermediate lip 30 in longitudinal cross section is located between the first bored portion 28 and an attachment concavity 32 described below in the axial direction, and is located off any of those first bored portion 28 and attachment concavity 32 in the axial direction.

An insertion rubber part 34 is provided at the lower end of the main rubber 20. The insertion rubber part 34 has a substantially tubular shape with a thin wall and a small diameter and protrudes downward at the radially inner end of the main rubber 20. The outer peripheral surface of the insertion rubber part 34 is an approximately cylindrical surface, and the radially inner surface is a corrugated surface whose radial dimension varies in the circumferential direction, and is flower-shaped as viewed in the axial direction (in bottom view) as shown in FIG. 3. More specifically, the radially inner end of the insertion rubber part 34 is provided with a plurality of support projections 36 projecting radially inward and a plurality of concave portions 38 retreating radially outward, which alternate in the circumferential direction. As a result, the inner diameter dimension is smaller in the portions where the support projections 36 are formed than in the portions where the concave portions 38 are formed. The radially inner surface of the support projections 36 and the concave portions 38 is constituted by a smoothly continuous curved surface in the circumferential direction.

The attachment concavity 32 is continuously provided around the entire circumference of the lower portion of the main rubber 20. The attachment concavity 32 has a notch shape opening to the outer peripheral surface and the lower surface of the main rubber 20. The attachment concavity 32 is partially provided with some outer peripheral engagement parts 40 protruding downward at the outer peripheral end and some radially inner engagement parts 42 projecting radially outward at the lower end of the radially inner end at multiple locations in the circumferential direction. As shown in FIG. 3, in the present practical embodiment, two outer peripheral engagement parts 40 are formed on both sides in the diametrical direction to position the separate rubber 22 in the circumferential direction, while eight radially inner engagement parts 42 are formed at almost equal intervals in the circumferential direction to prevent the separate rubber 22 from slipping downward. The main rubber 20 has a larger diameter partially in the circumferential direction at the portions where the outer peripheral engagement parts 40 are formed.

The separate rubber 22 is molded independently of the main rubber 20 and has an annular shape extending with an approximately rounded rectangular cross section. At the outer peripheral corner of the upper end of the separate rubber 22, a plurality of outer peripheral notches 52 corresponding to the outer peripheral engagement parts 40 of the main rubber 20 are partially formed in the circumferential direction. At the radially inner corner of the lower end of the separate rubber 22, a radially inner notch 54 corresponding to the radially inner engagement parts 42 of the main rubber 20 is formed continuously over the entire circumference. In this practical embodiment, the outer peripheral notches 52 are provided at two locations in the circumferential direction.

A reinforcement member 44 is embedded in and bonded to the separate rubber 22. The reinforcement member 44 is made of a metal, a synthetic resin, or the like, and has higher rigidity than the main rubber 20. The reinforcement member 44 has a tubular portion 46 that has a substantially cylindrical shape. The reinforcement member 44 has an inner flanged portion 48 projecting inward in the radial direction from the lower end of the tubular portion 46 and an outer flanged portion 50 projecting outward in the radial direction from the upper end of the tubular portion 46, which extend continuously over the entire circumference. The reinforcement member 44 of this practical embodiment is a pressed metal fitting in which the tubular portion 46, the inner flanged portion 48, and the outer flanged portion 50 are integrally formed. In the reinforcement member 44, the axial length dimension L should be larger than any of the projection dimension A of the inner flanged portion 48 to the radially inner side and the projection dimension B of the outer flanged portion 50 to the radially outer side.

In this practical embodiment, the separate rubber 22 takes the form of an integrally vulcanization molded component incorporating the reinforcement member 44, and the reinforcement member 44 is a separate component from the integrally vulcanized molded component of the main rubber 20. This eliminates arrangement of the reinforcement member 44 when the main rubber 20 is molded, and thus facilitates the molding process of the main rubber 20. The reinforcement member 44 is embedded in the separate rubber 22 as a whole, although the radially inner end of the inner flanged portion 48 is exposed to the outside by the radially inner notch 54.

The separate rubber 22 in which the reinforcement member 44 is embedded and bonded is attached to the main rubber 20. The separate rubber 22 is inserted into the attachment concavity 32 of the main rubber 20 from below by overcoming the radially inner engagement parts 42, and is prevented from falling out of the attachment concavity 32 by axial engagement with the radially inner engagement parts 42. In addition, the outer peripheral engagement parts 40 provided at the opening end of the attachment concavity 32 is inserted into the outer peripheral notches 52 of the separate rubber 22, thereby positioning the separate rubber 22 relative to the main rubber 20 in the circumferential direction. Thus, in the upper mount 12 of this practical embodiment, the first elastic body 18 is constituted by the separate rubber 22 being attached to the main rubber 20, and the reinforcement member 44 is buried in and bonded to the lower portion of the first elastic body 18.

The reinforcement member 44 bonded to the lower portion of the first elastic body 18 is overlapped with the first bored portion 28 as viewed in the axial direction. In the present practical embodiment, in the stand-alone state of the upper mount 12 before being mounted to the vehicle shown in FIG. 2, the entire reinforcement member 44 is located on the outer peripheral side of the radially inner end (the deepest portion) of the first bored portion 28, and overlapped with the first bored portion 28 as viewed in the axial direction. The first bored portion 28 is configured to be overlapped with the reinforcement member 44 as viewed in the axial direction in the single component state of the upper mount 12 before installation in the vehicle. When the upper mount 12 is mounted in the vehicle, the bottom portion of the first bored portion 28 may be out of alignment with the reinforcement member 44 to the outer peripheral side as shown in FIG. 1, because the vehicle body weight is loaded on it.

The reinforcement member 44 is arranged off to the upper side of the insertion rubber part 34 provided at the lower end of the first elastic body 18. Therefore, as viewed in the axis-perpendicular direction, the insertion rubber part 34 and the reinforcement member 44 are separated from each other without overlapping each other. Moreover, the reinforcement member 44 is also separated from the insertion rubber part 34 to the outer peripheral side and does not overlap with the insertion rubber part 34 as viewed in the axial direction.

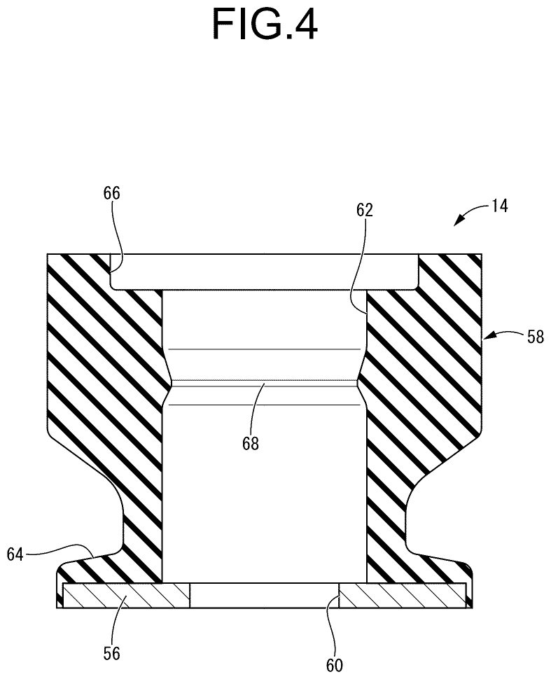

As shown in FIG. 4, the lower mount 14 is tubular as a whole, and has a structure wherein a second elastic body 58 is adhered to a lower plate 56. The lower plate 56 is a member of an approximately annular plate shape formed of a metal or the like, and a second bolt insertion hole 60 is formed through the center portion thereof in the thickness direction.

The second elastic body 58 is formed of a rubber or a resin elastomer, similar to the first elastic body 18. The second elastic body 58 has a generally cylindrical shape with a second inner hole 62 penetrating in the up-down direction. At the lower portion of the second elastic body 58, a second bored portion 64 is continuously formed around the entire circumference of the second elastic body 58, so as to open to the outer peripheral surface. The second bored portion 64 has a widened shape with an axial width dimension that increases to the outer peripheral side. The depth dimension of the second bored portion 64 is suitably half the radial dimension of the upper portion of the second elastic body 58 or more and in the present practical embodiment, it is approximately ⅔ times the radial dimension of the upper portion of the second elastic body 58.

The second inner hole 62 of the second elastic body 58 has a larger diameter at the upper end, which provides a large-diameter portion 66. As a result, the second elastic body 58 is thin-walled in the radial direction at the upper end where the large-diameter portion 66 is formed.

A second intermediate lip 68 projecting radially inward is provided on the radially inner surface of the second elastic body 58. The second intermediate lip 68 has a tapered cross-sectional shape that becomes narrower in the axial direction as it goes toward the projecting tip, and is formed continuously over the entire circumference.

As shown in FIG. 1, the upper mount 12 and the lower mount 14 are overlapped in the up-down direction, or in the axial direction, and a fastening member 70 is inserted through the first inner hole 26 of the first elastic body 18 of the upper mount 12 and the second inner hole 62 of the second elastic body 58 of the lower mount 14. The fastening member 70 is a member of high rigidity formed of a metal or the like, and has an approximately cylindrical shape with a small diameter that can be inserted into the first and second inner holes 26, 62 of the first and second elastic bodies 18, 58. Both axial end faces of the fastening member 70 butt against the upper plate 16 and the lower plate 56, and the first and second bolt insertion holes 24, 60 are connected to the inner hole of the fastening member 70.

Against the outer peripheral surface of the fastening member 70, the first and second intermediate lips 30, 68 projecting from the radially inner surfaces of the first and second inner holes 26, 62, and the plurality of support projections 36 projecting from the radially inner surface of the insertion rubber part 34 are pressed. As a result, the fastening member 70 is elastically supported by the first and second elastic bodies 18, 58. The radially inner surfaces of the first and second inner holes 26, 62 are separated from the outer peripheral surface of the fastening member 70 at a portion outside the first and second intermediate lips 30, 68.

A chassis frame 72 as a first vehicle member is sandwiched between the upper mount 12 and the lower mount 14, which are overlapped in the up-down direction. The chassis frame 72 is a plate-shaped metal material and is provided with an insertion hole 74 that penetrates it in the up-down direction. The opening peripheral edge of the insertion hole 74 in the chassis frame 72 is an insertion tube part 76 having a tubular shape protruding downward. An attachment recess 78 opening upward is formed at the radially inner portion of the chassis frame 72. The attachment recess 78 is shaped like a shallow-bottomed bowl having a bottom wall 80 and a peripheral wall 82 integrally, with the insertion hole 74 formed through the center portion of the bottom wall 80 and the insertion tube part 76 protruding downward from the radially inner end of the bottom wall 80.

The lower portion of the first elastic body 18 of the upper mount 12, including the separate rubber 22, is fitted into the attachment recess 78 of the chassis frame 72. At least a portion of the reinforcement member 44 bonded in the lower portion of the first elastic body 18 enters the attachment recess 78. Preferably, the lower end position C of the outer flanged portion 50 in the reinforcement member 44 is located below the upper end position D of the attachment recess 78. In the present practical embodiment, the entire reinforcement member 44 is positioned below the upper end of the attachment recess 78 and is arranged in the attachment recess 78 in a contained state.

The reinforcement member 44 is located on the outer peripheral side of the insertion hole 74 and the whole reinforcement member 44 overlaps the bottom wall 80 of the attachment recess 78 as viewed in the axial direction. Accordingly, the inner diameter dimension of the inner flanged portion 48 of the reinforcement member 44 is larger than the inner diameter dimension of the chassis frame 72 (the diameter of the insertion hole 74), and the outer diameter dimension of the outer flanged portion 50 of the reinforcement member 44 is smaller than the inside dimension of the attachment recess 78 in the axis-perpendicular direction.

The reinforcement member 44 is formed so that the distance between the outer flanged portion 50 and the peripheral wall 82 of the attachment recess 78 in the axis-perpendicular direction is shorter than the distance between the inner flanged portion 48 and the fastening member 70 to be described later in the axis-perpendicular direction. The distance from the lower end of the reinforcement member 44 to the upper surface of the bottom wall 80 of the attachment recess 78 is shorter than the distance between the outer flanged portion 50 and the peripheral wall 82 of the attachment recess 78 in the axis-perpendicular direction. Thus, the inner flanged portion 48 is arranged to face the chassis frame 72 in close proximity in the axial direction.

The insertion rubber part 34 of the upper mount 12 is inserted in the insertion hole 74 of the chassis frame 72 and extends in the axial direction between the fastening member 70 and the insertion tube part 76 of the chassis frame 72 in the radial direction.

The insertion tube part 76 of the chassis frame 72 is fitted in the large-diameter portion 66 of the second inner hole 62 in the lower mount 14. The lower end surface of the insertion tube part 76 is butted against the bottom surface of the large-diameter portion 66 in the axial direction.

The insertion rubber part 34 arranged radially inside the insertion tube part 76 is compressed in the axial direction, with its lower end surface being butted against the bottom surface of the large-diameter portion 66 in the axial direction. The insertion rubber part 34, which is compressed in the axial direction, tries to expand in the axis-perpendicular direction according to Poisson ratio, and thus it is pressed against the outer peripheral surface of the fastening member 70 and the radially inner surface of the insertion tube part 76, and is compressed in the radial direction between the fastening member 70 and the insertion tube part 76.

The radially inner surface of the insertion rubber part 34 has a flower shape with a series of alternating concavities and convexities in the circumferential direction, and it is pressed against the outer peripheral surface of the fastening member 70 at the support projections 36 as the convexities, and is separated from the fastening member 70 at the concave portions 38 as the concavities radially outward. This adjusts the spring constant of the insertion rubber part 34, and it is possible to adjust the spring characteristics in the axis-perpendicular direction of the upper mount 12, which is greatly affected by the spring constant of the insertion rubber part 34.

For the lower mount 14, the upper end surface of the second elastic body 58 is pressed against the lower surface of the bottom wall 80 of the attachment recess 78 of the chassis frame 72 on the outer peripheral side of the large-diameter portion 66, and the second elastic body 58 is compressed between the lower plate 56 and the chassis frame 72 in the axial direction.

The upper plate 16 and the lower plate 56 are positioned relative to each other in the axial direction by a mounting bolt 84. The mounting bolt 84 is inserted through the first bolt insertion hole 24 of the upper plate 16, the inner hole of the fastening member 70, and the second bolt insertion hole 60 of the lower plate 56. A nut 86 is fastened on the mounting bolt 84, thereby setting the distance between the surfaces of the upper plate 16 and the lower plate 56 facing each other in the axial direction to the length of the fastening member 70. As a result, the first elastic body 18 is compressed between the upper plate 16 and the chassis frame 72 in the axial direction, while the second elastic body 58 is compressed between the lower plate 56 and the chassis frame 72 in the axial direction. By compression of the first and second elastic bodies 18, 58 in the axial direction, the first and second bored portions 28, 64 have smaller areas in longitudinal cross section.

By the deformation caused by the compression of the first elastic body 18 in the axial direction, the separate rubber 22 is pressed against the inner surface of the attachment concavity 32 in the main rubber 20, eliminating the gap between the main rubber 20 and the separate rubber 22, so that the main rubber 20 and the separate rubber 22 are integrally continuous.

A portion of a cabin 88 as a second vehicle member is overlapped with the upper surface of the upper plate 16, and the cabin 88 is fastened to the upper plate 16 by the mounting bolt 84. By so doing, the upper mount 12 constituting the cab mount 10 is interposed between the chassis frame 72 and the cabin 88, and the chassis frame 72 and the cabin 88 are connected by the cab mount 10 in a vibration-damping manner. In this practical embodiment, a fixing shaft inserted through the upper mount 12 and the lower mount 14 comprises the fastening member 70 and the mounting bolt 84 inserted through the fastening member 70, and the cab mount 10 is fixed to the cabin 88 by the fixing shaft.

When axial vibration is input between the chassis frame 72 and the cabin 88 in the vehicle-mounted state of the cab mount 10, either the first elastic body 18 of the upper mount 12 or the second elastic body 58 of the lower mount 14 is compressed in the axial direction, thereby providing vibration-damping effect based on internal friction, etc. In addition, the vibration-damping effect is achieved by the deformation of the first and second elastic bodies 18, 58 also against the vibration input in the axis-perpendicular direction.

It is desirable that the spring constant in the up-down direction of the cab mount 10 should be set small while keeping necessary support spring rigidity in the up-down direction for the purpose of good ride comfort, etc. Similarly, the spring constant in the left-right direction of the cab mount 10 should also be small considering ride comfort performance, etc. On the other hand, it is desirable to set the spring constant in the prizing direction of the cab mount 10 large for the purpose of suppressing swings of the cabin 88 when the vehicle is turning.

In the cab mount 10 of this practical embodiment, the reinforcement member 44 is embedded in and bonded to the lower portion of the first elastic body 18 in the upper mount 12, and the reinforcement member 44 has a shape provided with the tubular portion 46 extending in the axial direction. As a result, the tubular portion 46 of the reinforcement member 44 tries to displace in the inclined direction during input in the prizing direction, so that the working area of the first elastic body 18 where the compressive or tensile force is applied by the tubular portion 46 becomes larger, and the spring constant for input in the prizing direction becomes larger.

The tubular portion 46 of the reinforcement member 44 has a small projected area in the axial direction, so that it rarely affects the spring constant during axial input, resulting in soft spring characteristics in the axial direction.

The reinforcement member 44 is positioned, in the axial direction, off to the upper side of the insertion rubber part 34, which has a significant effect on the spring constant in the axis-perpendicular direction of the upper mount 12. This suppresses the effect of the reinforcement member 44 on the spring constant of the upper mount 12 in the axis-perpendicular direction, thereby realizing soft spring characteristics even in the axis-perpendicular direction.

The reinforcement member 44 of this practical embodiment has the inner flanged portion 48 projecting inward in the radial direction at the lower end thereof. This causes the thin-walled rubber to be compressed between the inner flanged portion 48 and the chassis frame 72 (the bottom wall 80 of the attachment recess 78) when the tubular portion 46 of the reinforcement member 44 tries to tilt. As a result, the spring constant against input in the prizing direction is increased, preventing the cabin 88 from swinging, etc. during turning due to hard spring characteristics.

The reinforcement member 44 also has the outer flanged portion 50 projecting outward in the radial direction at the upper end thereof. This causes the rubber to be compressed also between the outer flanged portion 50 and the chassis frame 72 when the tubular portion 46 of the reinforcement member 44 tries to tilt, thereby increasing the spring constant against input in the prizing direction.

The reinforcement member may be provided with an inner flanged portion projecting inward in the radial direction at the upper end of the tubular portion and an outer flanged portion projecting outward in the radial direction at the lower end of the tubular portion. However, considering the accommodability of the reinforcement member 44 in the attachment recess 78 and tuning of the spring characteristics, and the like, it is desirable that the lower end of the tubular portion 46 be provided with the inner flanged portion 48 projecting inward in the radial direction while the upper end of the tubular portion 46 be provided with the outer flanged portion 50 projecting outward in the radial direction, as in the reinforcement member 44 in this practical embodiment.

In the reinforcement member 44 of this practical embodiment, the axial length dimension L is larger than any of the projection dimension A of the inner flanged portion 48 to the radially inner side and the projection dimension B of the outer flanged portion 50 to the radially outer side. This suppresses the increase in the rubber compression area in the axial direction by the inner flanged portion 48 and the outer flanged portion 50, whereby it is possible to prevent the compression spring characteristics in the axial direction from becoming excessively hard, while further efficiently increasing the prizing spring owing to the inclination of the reinforcement member 44 (the tubular portion 46).

The lower portion of the upper mount 12 is fitted in the attachment recess 78 provided in the chassis frame 72, whereby the lower portion of the upper mount 12 is positioned and held relative to the chassis frame 72 by a simple fitting-in structure.

The reinforcement member 44 located in the lower portion of the upper mount 12 enters the attachment recess 78, which effectively provides hard spring characteristics against the prizing input, owing to compression or tension of the thin-walled rubber interposed between the reinforcement member 44 and the attachment recess 78.

In this practical embodiment, the lower end position C of the outer flanged portion 50 in the reinforcement member 44 is positioned below the upper end position D of the attachment recess 78, so that the outer flanged portion 50 is close to and overlapped with the peripheral wall 82 of the attachment recess 78 in the radial direction, as they face each other. By so doing, the first elastic body 18, which is compressed by the outer flanged portion 50 tilting relative to the chassis frame 72 during input in the prizing direction, hardly ever escapes upward in the axial direction, thereby enabling the prizing spring to be increased more efficiently.

In particular, in this practical embodiment, the entire reinforcement member 44 is located in the attachment recess 78 and does not protrude outward in the axial direction, so that the axial free length of the first elastic body 18 is hardly shortened by the reinforcement member 44 and the soft spring characteristics in the axial direction and the axis-perpendicular direction are kept. The reinforcement member 44 does not project inward and outward in the radial direction from the bottom wall 80 of the attachment recess 78, and the inner diameter dimension of the inner flanged portion 48 is larger than the diameter of the insertion hole 74, and the outer diameter dimension of the outer flanged portion 50 is smaller than the inside dimension of the peripheral wall 82 of the attachment recess 78. Owing to this, it is possible to obtain a large spring constant owing to compression or tension of the thin-walled rubber between the reinforcement member 44 and the attachment recess 78 during input in the prizing direction.

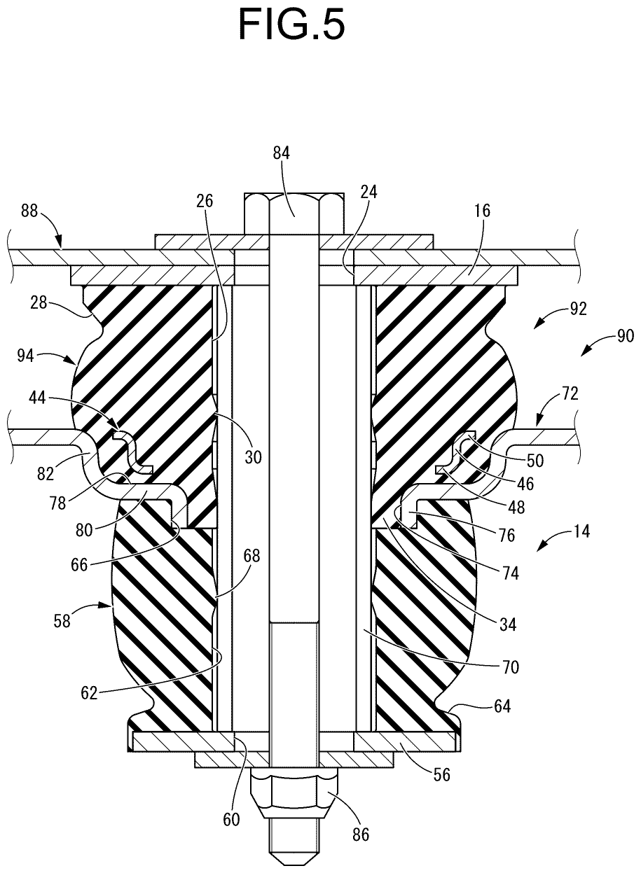

FIG. 5 shows a cab mount 90 as a second practical embodiment of the present disclosure. The cab mount 90 comprises an upper mount 92 and the lower mount 14. In this practical embodiment, components and parts that are substantially the same as those of the first practical embodiment may be omitted from the description, by providing the same symbols for them in the figures.

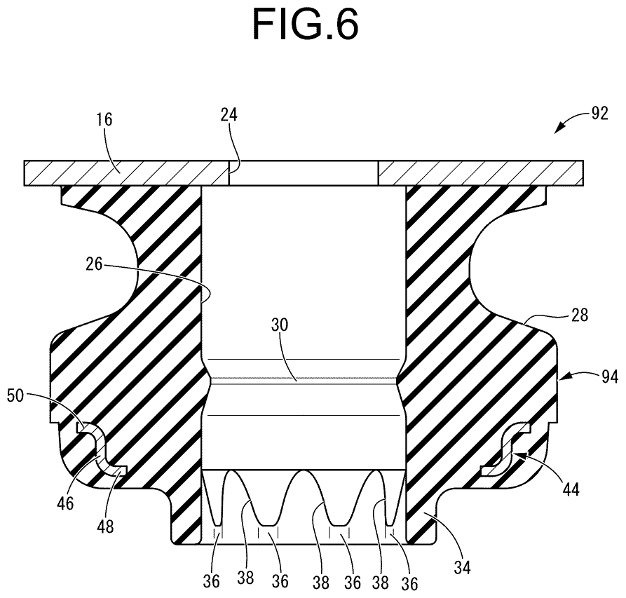

The upper mount 92 has a structure wherein the upper plate 16 and the reinforcement member 44 are adhered to a first elastic body 94 as an elastic body, as also shown in FIG. 6. The first elastic body 94 is shaped as a combination of the main rubber 20 and the separate rubber 22 of the first practical embodiment. The first elastic body 94 is not provided with the attachment concavity 32 as in the first practical embodiment, and the reinforcement member 44 is directly bonded to the lower portion of the first elastic body 94 and arranged in an embedded state. The first elastic body 94 of this practical embodiment takes the form of an integrally vulcanization molded component incorporating the upper plate 16 and the reinforcement member 44.

According to this cab mount 10 of this practical embodiment, the entire upper mount 92 takes the form of an integrally vulcanization molded component of the first elastic body 94. This makes it possible to reduce the molding process of the elastic body, compared to the first practical embodiment wherein the vulcanization molded component of the main rubber 20 incorporating the upper plate 16 and the vulcanization molded component of the separate rubber 22 incorporating the reinforcement member 44 must be molded separately.

Although the practical embodiments of the present disclosure have been described in detail above, the present disclosure is not limited by that specific description. For example, the reinforcement member 44 need only have the tubular portion 46, and either the inner flanged portion 48 or the outer flanged portion 50 may be provided, or none of them may be provided. The tubular portion 46 of the reinforcement member 44 can also be, for example, a tapered tubular shape with an upwardly expanding diameter or an upwardly decreasing diameter or a curved, tapered tubular shape with an inclination angle changing in the axial direction.

In the vehicle-mounted state of the cab mount 10, the reinforcement member 44 need not be entirely contained in the attachment recess 78 of the chassis frame 72, but may only be partially inserted. The reinforcement member 44 need not enter the attachment recess 78 and need not be overlapped with the chassis frame 72 as viewed in the axis-perpendicular direction. The attachment recess 78 is dispensable in the chassis frame 72.

The shape of the first elastic body 18 of the upper mount 12 is not limited by the specific description of the above-described practical embodiments and can be changed as appropriate. Specifically, the shape, the size, and the like of the first bored portion 28 and the attachment concavity 32 can be changed as appropriate depending on the required spring characteristics, etc. Similarly, the shape of the second elastic body 58 of the lower mount 14 is not limited by the specific description of the aforesaid practical embodiments.

The radially inner surface of the insertion rubber part 34 should be flower-shaped as in the above-mentioned practical embodiments in order to advantageously tune the spring characteristics, but it can also be, for example, in an approximately cylindrical shape with a constant inner diameter. When the radially inner surface of the insertion rubber part 34 is provided with flower-shaped concave/convex portions, the number of concave/convex portions is not particularly limited, and the shape and radial height (depth) of the concave/convex portions are also set as appropriate.

What is claimed is:

1. A cab mount comprising:
an upper mount and a lower mount configured to be assembled as sandwiching a first vehicle member;
a fixing shaft inserted through the upper mount and the lower mount so as to fix the cab mount to a second vehicle member;
an elastic body constituting the upper mount;
an insertion rubber part provided at a lower end of the elastic body and configured to extend between the first vehicle member and the fixing shaft in a radial direction; and
a reinforcement member including a tubular portion that extends in an axial direction and being embedded in and bonded to a lower portion of the elastic body, the reinforcement member being arranged off to an upper side of the insertion rubber part.

2. The cab mount according to claim 1, wherein a lower end of the tubular portion has an inner flanged portion projecting inward in the radial direction.

3. The cab mount according to claim 1, wherein an upper end of the tubular portion has an outer flanged portion projecting outward in the radial direction.

4. The cab mount according to claim 1, wherein the reinforcement member is embedded in and bonded to an annular separate rubber, and the separate rubber is attached to a lower portion of a main rubber so as to constitute the elastic body so that the reinforcement member is embedded in and bonded to the lower portion of the elastic body.

5. The cab mount according to claim 1, configured to be used for the first vehicle member having an attachment recess opening upward which is provided at a radially inner portion thereof, wherein
the lower portion of the elastic body is configured to be fitted into the attachment recess so that the reinforcement member bonded to the lower portion of the elastic body enters the attachment recess.

6. The cab mount according to claim 5, wherein an inner diameter dimension of the reinforcement member is larger than an inner diameter dimension of the first vehicle member, and an outer diameter dimension of the reinforcement member is smaller than an inside dimension of the attachment recess.

7. The cab mount according to claim 1, wherein
in an upper portion of the elastic body, a constricted, bored portion is formed opening to an outer peripheral surface thereof, and
the reinforcement member is overlapped with the bored portion as viewed in the axial direction.

8. The cab mount according to claim 1, wherein an inner diameter dimension of the insertion rubber part varies in a circumferential direction and the insertion rubber part is flower-shaped as viewed in the axial direction.
